(19) United States
(12) Patent Application Publication
(10) Pub. No.: US 2026/0279686 A1
(43) Pub. Date: Sep. 17, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Jinwoo Kim, Suwon-si (KR); Subeen Kim, Suwon-si (KR); Heesang Kang, Suwon-si (KR); Youjin Kim, Suwon-si (KR); Byoung Uk Ahn, Suwon-si (KR); Jeong Ryeol Kim, Suwon-si (KR)

(73) Assignee: SAMSUNG ELECTRO-MECHANICS CO., LTD., Suwon-si (KR)

(21) Appl. No.: 19/383,018

(22) Filed: Nov. 7, 2025

(30) Foreign Application Priority Data
Mar. 14, 2025 (KR) 10-2025-0033140

(51) Int. Cl. H01G 4/30; H01G 4/12

(52) U.S. Cl. CPC H01G 4/306; H01G 4/1245; H01G 4/129

(57) ABSTRACT

A multilayer ceramic capacitor includes a capacitor body including a dielectric layer and an internal electrode layer, and an external electrode located on the outside of the capacitor body, wherein the dielectric layer includes a plurality of dielectric grains, at least one of the plurality of dielectric grains includes Ca, Sr, Zr, and Ti, at least one of the plurality of dielectric grains has a core-shell structure including a core portion and a shell portion disposed on at least a portion of the core portion, a content of Ti included in the shell is 5 mol % to 10 mol % based on a total amount of Zr and Ti included in the shell portion, and a content of Sr included in the shell portion is 32 mol % to 65 mol % based on a total amount of Ca and Sr included in the shell portion.

### CROSS-REFERENCE TO RELATED APPLICATION

This application claims priority to and the benefit of Korean Patent Application No. 10-2025-0033140 filed at the Korean Intellectual Property Office on Mar. 14, 2025, the entire contents of which are incorporated herein by reference.

### BACKGROUND

### (a) Technical Field

The present disclosure relates to a multilayer ceramic capacitor and a method of manufacturing the same.

### (b) Description of the Related Art

Electronic components that use ceramic materials include capacitors, inductors, piezoelectric elements, varistors, and thermistors. Among these ceramic electronic components, a multilayer ceramic capacitor MLCC may be used in various electronic devices due to its advantages of being compact, having high capacity, and being easy to mount.

For example, multilayer ceramic capacitors may be used as chip-shaped capacitors mounted on the substrates of various electronic products, such as liquid crystal displays (LCDs), plasma display panels (PDPs), and organic light emitting diodes (OLEDs), as well as in imaging devices such as computers, personal portable terminals, and smartphones, to charge or discharge electricity.

With the recent miniaturization of electronic products, multilayer ceramic capacitors are also required to be ultra-small and have ultra-high capacity. To this end, multilayer ceramic capacitors are being manufactured with a structure in which the dielectric layers and internal electrode layers are thinned and a greater number of dielectric layers and internal electrode layers are laminated. These ultra-small and ultra-high-capacity multilayer ceramic capacitors have recently been used in fields requiring a high level of reliability, such as electric vehicles, and therefore high stability and reliability are required.

### SUMMARY

An embodiment provides a multilayer ceramic capacitor with improved reliability.

Another embodiment provides a method of manufacturing the multilayer ceramic capacitor.

A multilayer ceramic capacitor according to an embodiment of the present disclosure includes a capacitor body including a dielectric layer and an internal electrode layer, and an external electrode located on an outside of the capacitor body, wherein the dielectric layer includes a plurality of dielectric grains, at least one dielectric grain among the plurality of dielectric grains includes Ca, Sr, Zr, and Ti, the at least one dielectric grain having a core-shell structure including a core portion and a shell portion disposed on at least a portion of the core portion, a content of Ti included in the shell is 5 mol % to 10 mol % based on a total amount of Zr and Ti included in the shell portion, and a content of Sr included in the shell portion is 32 mol % to 65 mol % based on a total amount of Ca and Sr included in the shell portion.

A content of Ti included in the core portion may be greater than 0 mol % and less than 5 mol % based on a total amount of Zr and Ti included in the core portion.

A content of Sr included in the core portion may be greater than 0 mol % and less than 32 mol % based on a total amount of Ca and Sr included in the core portion.

The dielectric grains may further include a first rare earth element and a second rare earth element different from the first rare earth element.

The first rare earth element comprises at least one element selected from the group consisting of elements having an ionic radius larger than that of yttrium (Y).

The first rare earth element may include at least one selected from Gd, Dy, Sm, and La.

The second rare earth element may include at least one selected from the group consisting of Y and elements having an ionic radius smaller than that of Y.

The second rare earth element may include at least one selected from Y, Yb, and Ho.

An amount in parts by mole of the first rare earth element included in the shell portion based on 100 parts by mole of Ca included in the shell portion may be defined as R1, and an amount in parts by mole of the second rare earth element included in the shell portion based on 100 parts by mole of Ca included in the shell portion may be defined as R2, and may be 0.05≤R1≤3.45, 0.05≤R2≤3.45, and 0.1≤R1+R2≤3.5.

An amount in parts by mole of the first rare earth element included in the shell portion based on 100 parts by mole of Ca included in the shell portion may be defined as R1, and an amount in parts by mole of the second rare earth element included in the shell portion based on 100 parts by mole of Ca included in the shell portion may be defined as R2, and may be 0.8≤R1≤1.0, 2.2≤R2≤3.0, and 3.0≤R1+R2≤3.5.

An amount in parts by mole of the first rare earth element included in the core portion based on 100 parts by mole of Ca included in the core portion may be defined as R3, and an amount in parts by mole of the second rare earth element included in the core portion based on 100 parts by mole of Ca included in the core portion may be defined as R4, and may be 0≤R3+R4≤0.5.

In a cross-section passing through a center of the at least one dielectric grain, the center of the at least one dielectric grain may be defined as a, and a point on a surface of the shell portion that is farthest from a may be defined as b, and a length of the core portion may be 15% to 85% of the shortest length from a to b.

The number of the at least one dielectric grain may be 5% to 100% of a total number of dielectric grains included in the dielectric layer.

In a straight-line section extending from one grain boundary of the at least one dielectric grain to another grain boundary and passing through the center point of the at least one dielectric grain, a length corresponding to the core portion may be 15 nm to 150 nm, and a total length corresponding to the shell portion may be 170 nm to 190 nm.

A method of manufacturing a multilayer ceramic capacitor according to an embodiment of the present disclosure includes preparing a dielectric powder doped with Sr and Ti in a base material containing Ca and Zr, preparing a dielectric slurry containing the dielectric powder, preparing a plurality of dielectric green sheets from the dielectric slurry and forming a conductive paste layer on the surface of at least one dielectric green sheet among the plurality of dielectric green sheets, laminating the plurality of the dielectric green sheets having the conductive paste layer formed on the at least one dielectric green sheet to prepare a dielectric green sheet laminate, firing the dielectric green sheet laminate to manufacture a capacitor body including a dielectric layer and an internal electrode, and forming an external electrode on a surface of the capacitor body.

A doping amount of Ti may be 5.5 parts by mole to 15 parts by mole based on 100 parts by mole of Ca.

A doping amount of Sr may be 25 parts by mole to 65 parts by mole based on 100 parts by mole of Ca.

The base material may be further doped with a first rare earth element and a second rare earth element different from the first rare earth element.

The first rare earth element may include at least one selected from Gd, Dy, Sm, and La.

The second rare earth element may include at least one selected from Y, Yb, and Ho.

According to an embodiment of the present disclosure, a quality factor (Q-factor) and a temperature coefficient of capacitance (TCC) of the multilayer ceramic capacitor 100 may be maintained or improved while the content of Ti included in dielectric grains is appropriately controlled to improve the permittivity.

According to an embodiment of the present disclosure, by appropriately controlling Sr content of the dielectric grains, the Q-factor and the TCC may be improved while the decrease in the permittivity may be relatively suppressed.

Since Ti and Sr included in the dielectric grains are distributed more in the shell portion than in the core portion or grain boundary, the durability, stability, and capacity characteristics of the multilayer ceramic capacitor may be improved.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor cut along line I-I′ of FIG. 1.

FIG. 3 is a cross-sectional view of the multilayer ceramic capacitor cut along line II-II′ of FIG. 1.

FIG. 4 is a schematic view illustrating dielectric grains of a multilayer ceramic capacitor according to an embodiment.

FIG. 5 shows transmission electron microscope-energy dispersive X-ray spectroscopy (TEM-EDS) analysis image and line scanning analysis results for dielectric grains of a multilayer ceramic capacitor according to Example 1.

FIGS. 6A and 6B are graphs showing the permittivity according to Titanium (Ti) content of a dielectric layer of the multilayer ceramic capacitor according to Examples 1 to 12 and Comparative Examples 1 to 12.

FIGS. 7A and 7B are graphs showing a quality factor (Q-factor) according to Ti content of the dielectric layer of the multilayer ceramic capacitor according to Examples 1 to 12 and Comparative Examples 1 to 12.

FIGS. 8A to 8C are graphs showing a temperature coefficient of capacitance (TCC) and the permittivity according to Ti content of the dielectric layer of the multilayer ceramic capacitor according to Examples 1 to 9 and Comparative Examples 1, 4, and 7.

FIGS. 9A to 9C are graphs showing the permittivity and TCC according to the strontium (Sr) content of the dielectric layer of the multilayer ceramic capacitor according to Examples 13, 14, 16, 17, 19, and 20 and Comparative Examples 13, 14, 16, 17, 19, and 20.

FIGS. 10A and 10B are graphs showing the permittivity according to the dysprosium (Dy) and yttrium (Y) content of the dielectric layer of the multilayer ceramic capacitor according to Examples 22 to 37.

FIG. 11 is a graph showing the Q-factor according to the Dy and Y contents of the dielectric layer of the multilayer ceramic capacitor according to Examples 22 to 37.

### DETAILED DESCRIPTION

Hereinafter, the present disclosure will be described in detail with reference to the accompanying drawings, in which embodiments of the present disclosure are shown. The drawings and description are to be regarded as illustrative in nature and not restrictive, and like reference numerals designate like elements throughout the specification. In the accompanying drawings, some components are exaggerated, omitted, or schematically illustrated, and the size of each component does not entirely reflect the actual size.

The accompanying drawings are intended only to facilitate understanding of the exemplary embodiments disclosed in this specification, and it is to be understood that the technical ideas disclosed herein are not limited by the accompanying drawings and include all modifications, equivalents, or substitutions that are within the range of the ideas and technology of the present disclosure.

Although terms “first,” “second,” and the like are used to explain various components, the components are not limited to such terms. These terms are only used to distinguish one component from another component.

It should be understood that when an element such as a layer, film, region, or substrate is referred to as being “on” or “above” another element, it may be directly on the other element or intervening elements may also be present. In contrast, when an element is referred to as being “directly on” another element, there are no intervening elements present. Further, when an element is referred to as being “on” or “above” a reference element, it may be positioned above or below the reference element, and it may not necessarily be referred to as being positioned “on” or “above” it in a direction opposite to gravity.

Throughout the specification, the terms “comprise” and “have” are intended to specify the presence of stated features, numbers, steps, operations, components, or a combination thereof, but do not preclude the presence or addition of one or more other features, numbers, steps, operations, components, and/or groups thereof. Therefore, unless explicitly stated to the contrary, the word “comprise” and variations such as “comprises” and “comprising” should be understood to imply the inclusion of stated elements but not the exclusion of any other elements.

In addition, the phrase “on a plane” means a view from a position above the object (e.g., from the top), and the phrase “in a cross-section” means a view of a cross-section of the object which is vertically cut from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

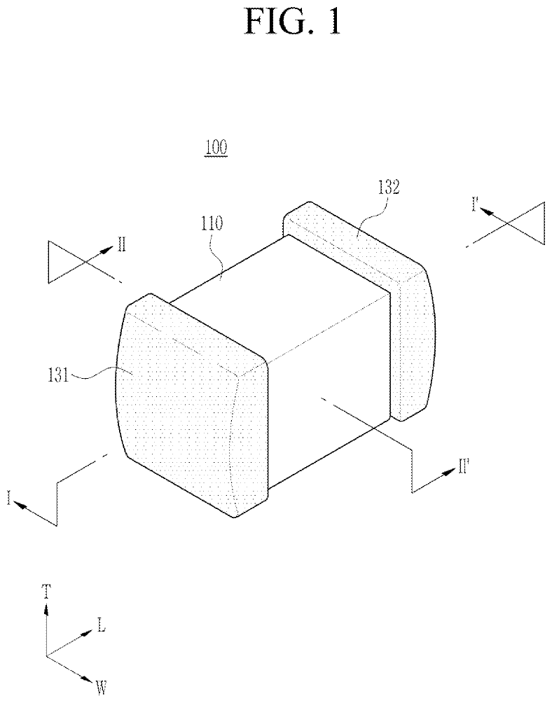

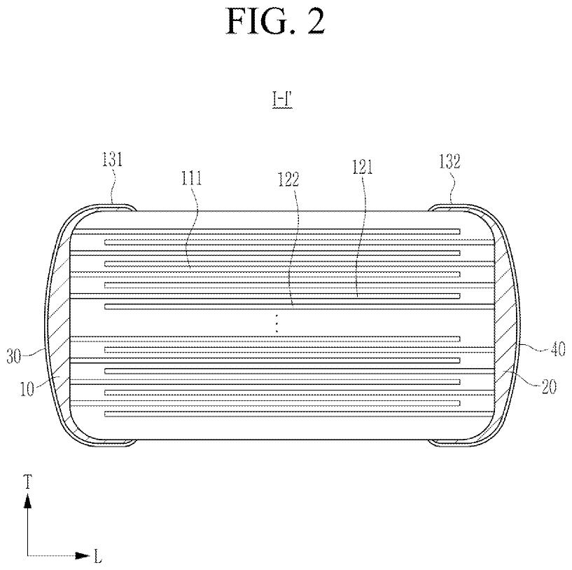

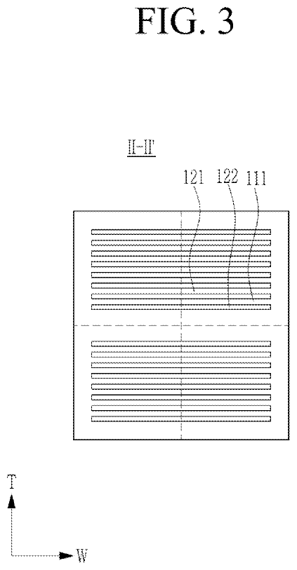

FIG. 1 is a perspective view schematically illustrating a multilayer ceramic capacitor according to an embodiment. FIG. 2 is a schematic cross-sectional view of a multilayer ceramic capacitor 100 taken along line I-I′ of FIG. 1. FIG. 3 is a schematic cross-sectional view of the multilayer ceramic capacitor 100 taken along line II-II′ of FIG. 1.

Referring to FIGS. 1 to 3, the multilayer ceramic capacitor 100 may include a capacitor body 110, and external electrodes 131 and 132 disposed on the outside of the capacitor body 110. The external electrodes 131 and 132 may include a first external electrode 131 and a second external electrode 132 disposed at both ends facing in a length direction (L-axis direction) of the capacitor body 110.

The L-axis, W-axis, and T-axis shown in FIGS. 1 to 3 represent a length direction, a width direction, and a lamination direction of the capacitor body 110, respectively. Here, for example, the lamination direction (T-axis direction) may be a direction perpendicular to the wide surface (main surface) of sheet-shaped components, and may be used interchangeably as the lamination direction in which the dielectric layer 111 is laminated. The length direction (L-axis direction) may be a direction that is approximately perpendicular to the lamination direction (T-axis direction) and extends parallel to the wide surface (main surface) of the sheet-shaped components, and may be, for example, a direction in which the first external electrode 131 and the second external electrode 132 are positioned on both sides. The width direction (W-axis direction) may be a direction that is approximately perpendicular to the lamination direction (T-axis direction) and the length direction (L-axis direction) and extends parallel to the wide surface (main surface) of the sheet-shaped components, and the length in the length direction (L-axis direction) of the sheet-shaped components may be greater than the length in the width direction (W-axis direction).

For example, the capacitor body 110 may have a roughly hexahedral shape.

Hereinafter, for convenience of description, both surfaces facing in the lamination direction (T-axis direction) of the capacitor body 110 are defined as a first surface and a second surface, both surfaces connected to the first surface and the second surface and facing in the length direction (L-axis direction) are defined as a third surface and a fourth surface, and both surfaces connected to the first surface and the second surface, connected to the third surface and the fourth surface, and facing in width direction (W-axis direction) are defined as a fifth surface and a sixth surface.

The first surface, which is a lower surface of the capacitor body 110, may be a surface facing the mounting direction of the multilayer ceramic capacitor 100. At least one of the first surface to the sixth surface may be flat. Alternatively, at least one of the first surface S1 to the sixth surface S6 may be curved surfaces with a convex central portion, and the edges, which are the boundaries of each surface, may be rounded.

The shape and size of the capacitor body 110 and the number of laminations of the dielectric layers 111 are not limited to those shown in the drawings of the present disclosure.

The capacitor body 110 may include the dielectric layer 111 and internal electrodes 121 and 122. The capacitor body 110 may include a plurality of dielectric layers 111. The internal electrodes 121 and 122 may include first internal electrodes 121 and second internal electrodes 122 that are alternately and repeatedly arranged in the lamination direction (T-axis direction).

The capacitor body 110 may include the plurality of dielectric layers 111, and the first internal electrodes 121 and the second internal electrodes 122 alternately arranged in the lamination direction (T-axis direction) with the dielectric layers 111 interposed therebetween.

The boundaries between adjacent dielectric layers 111 may be so integrated that they are difficult to identify without using a scanning electron microscope (SEM).

The capacitor body 110 may include an active region. The active region may be a region that contributes to forming Capacity of the multilayer ceramic capacitor 100. For example, the active region may be a region where the first internal electrode 121 or the second internal electrode 122 laminated in the lamination direction (T-axis direction) overlap.

The capacitor body 110 may further include a cover region and a side margin region.

The cover region may be positioned adjacent to the first surface and the second surface of the active region in the lamination direction (T-axis direction) as a lamination-direction margin portion. For example, a single dielectric layer 111 or two or more dielectric layers 111 may be laminated on the upper and lower surfaces of the active region, respectively, to provide the cover region.

The side margin region may be positioned adjacent to the fifth surface and the sixth surface of the active region in the width direction (W-axis direction) as a width-direction margin portion. The side margin region may be formed by applying a conductive paste layer on only a part of the surface of the dielectric green sheet, and not applying the conductive paste layer on both sides of the surface of the dielectric green sheet, and then stacking the dielectric green sheets.

For example, the cover region and the side margin region may prevent damage to the first internal electrode 121 and the second internal electrode 122 due to physical or chemical stress.

The dielectric layer 111 may include a base material as a primary component. For example, by using the base material, the dielectric properties of the multilayer ceramic capacitor 100 may be secured.

The base material may include BaTiO₃, BaZrO₃, BaSnO₃, CaTiO₃, CaZrO₃, CaSnO₃, SrTiO₃, SrZrO₃, SrSnO₃, and the like. These may be used alone or in combination of two or more.

According to an embodiment, the dielectric layer 111 may include CaZrO₃ as a primary component.

The dielectric layer 111 may further include a secondary component.

The secondary component may include tin (Sn), manganese (Mn), chromium (Cr), silicon (Si), aluminum (Al), magnesium (Mg), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), vanadium (V), and the like. These may be used alone or in combination of two or more.

According to an embodiment of the present disclosure, the dielectric layer 111 may include Zr and Ti as the secondary components.

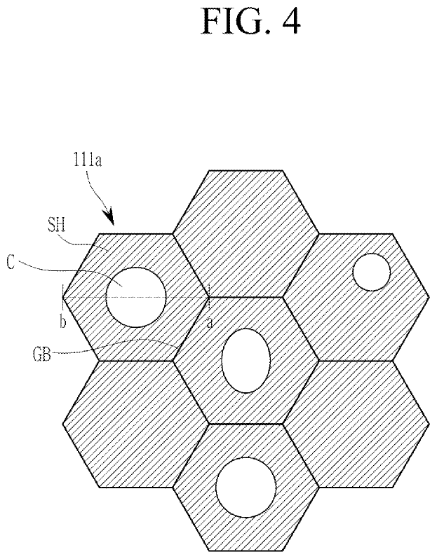

FIG. 4 is a schematic view illustrating dielectric grains of the multilayer ceramic capacitor 100 according to an embodiment.

Referring to FIG. 4, the dielectric layer 111 may include a plurality of dielectric grains 111a each including Ca, Sr, Zr, and Ti. For example, the dielectric layer 111 and/or the dielectric grains 111a may be formed by doping Sr and Ti into a CaZrO₃ base material.

Ca and Sr may be arranged at an A-site within the crystal structure of the dielectric grain 111a, and Zr and Ti may be arranged at a B-site within the crystal structure of the dielectric grain 111a. The A-site and the B-site may represent different layers arranged alternately within a hexagonal close-packed structure.

At least one of the plurality of dielectric grains 111a may have a core-shell structure.

The core-shell structure may include a core portion C and a shell portion SH disposed on at least a portion of the core portion C.

Ca and Zr of the dielectric grains 111a may be included in relatively large amounts in the core portion C, and Sr and Ti may be included in relatively large amounts in the shell portion SH. Accordingly, the permittivity of the dielectric layer 111 may be improved while capacity characteristics and driving stability of the multilayer ceramic capacitor 100 may be improved.

The content of Ti included in the shell portion SH may be 5 mol % to 10 mol % based on a total amount of Zr and Ti included in the shell portion SH, and in another embodiment, 7 mol % to 10 mol %. In the above ranges, the permittivity of the dielectric layer 111 may be improved, and Capacity characteristics and stability of the multilayer ceramic capacitor 100 may be improved. In the above ranges, a quality factor (Q-factor) and a temperature coefficient of capacitance (TCC) of the multilayer ceramic capacitor 100 may be maintained or improved while the permittivity is improved, depending on the content of Ti. The Q-factor represents the reactance of the multilayer ceramic capacitor 100 divided by the equivalent series resistance (ESR), and the TCC may represent the change in capacitance according to temperature change.

The content of Sr included in the shell portion SH may be 32 mol % to 65 mol % based on a total amount of Ca and Sr included in the shell portion SH, and in another embodiment, 32 mol % to 40 mol %. In the above ranges, the decrease in permittivity may be relatively suppressed as the Q-factor and the TCC are improved.

The contents of Sr and Ti of the core portion C may be relatively smaller than the contents of Sr and Ti of the shell portion SH. Accordingly, by maintaining a stable CaZrO₃ structure in the core portion C, the permittivity may be improved and the reliability of the multilayer ceramic capacitor 100 may be further improved.

The content of Ti included in the core portion (C) may be greater than 0 mol % and less than 5 mol % based on a total amount of Zr and Ti included in the core portion C, and in other embodiments, may be greater than 0 mol % and less than or equal to 3 mol %. In the above ranges, the reduction resistance of the dielectric layer may be further improved and the occurrence of internal defects may be further suppressed. Accordingly, the Q-factor and the TCC may be further improved.

The content of Sr included in the core portion C may be greater than 0 mol % and less than 32 mol % based on a total amount of Ca and Sr included in the core portion C, and in other embodiments, may be greater than 0 mol % and less than or equal to 25 mol %. In the above ranges, the withstand voltage characteristics and stability of the multilayer ceramic capacitor 100 may be further improved while the TCC may be maintained or improved.

The dielectric grains 111a may further include a first rare earth element and a second rare earth element different from the first rare earth element.

The first rare earth element may have a relatively large ionic radius, and the second rare earth element may have a relatively small ionic radius. Accordingly, the trade-off relationship between permittivity and the Q-factor may be alleviated through two different rare earth elements.

The first rare earth element may include at least one selected from the group consisting of elements having an ionic radius larger than that of yttrium (Y). The first rare earth element may include at least one of Gd, Dy, Sm, and La.

The second rare earth element may include at least one selected from the group consisting of Y and elements having an ionic radius smaller than that of Y. The second rare earth element may include at least one of Y, Yb, and Ho.

An amount in parts by mole of the first rare earth element included in the shell portion SH based on 100 parts by mole of Ca included in the shell portion SH may be defined as R1, and an amount in parts by mole of the second rare earth element included in the shell portion SH based on 100 parts by mole of Ca included in the shell portion SH may be defined as R2. In this case, 0.05≤R133.45, 0.05≤R233.45, and 0.1≤R1 R2≤3.5, and in other embodiments, 0.8≤R1≤1.0, 2.2≤R2≤3.0, and 3.0≤R1+R2≤3.5. The contents of the first rare earth element and the second rare earth element may be adjusted together within the above ranges so that the permittivity, withstand voltage, and thermal stability may be further improved together.

An amount in parts by mole of the first rare earth element included in the core portion C based on 100 parts by mole of Ca included in the core portion C may be defined as R3, and an amount in parts by mole of the second rare earth element included in the core portion C based on 100 parts by mole of Ca included in the core portion C may be defined as R4. In this case, 0≤R3+R4≤0.5. In the above range, the stable crystal structure of the core portion C is maintained, so that the thermal stability and driving reliability of the multilayer ceramic capacitor 100 may be further improved.

In an embodiment, the dielectric layer 111 may further include a grain boundary GB arranged between a plurality of dielectric grains 111a.

The dielectric layer 111 may include Si. The Si content may be the largest in the grain boundary GB among the core portion C, the shell portion SH, and the grain boundary GB. Accordingly, the stability between the plurality of dielectric grains 111a and the density of the dielectric layer 111 may be further improved, and the withstand voltage characteristics and stability of the multilayer ceramic capacitor 100 may be further improved.

As shown in FIG. 4, a straight-line section extending from one grain boundary GB (a) of a dielectric grain 111a having the core-shell structure to another grain boundary GB (b) and passing through the center point of the dielectric grain 111a may be set (line a-b in FIG. 4). In the above straight-line section, a length of the core portion C may be 15% to 85% of the shortest length from a to b, and in other embodiments, 30% to 70%. In the above ranges, the permittivity may be improved while the stable crystal structure of the dielectric grains 111a is sufficiently maintained. Additionally, the Q-factor and the TCC may be further improved.

The number of dielectric grains 111a having the core-shell structure may be 5% to 100% of a total number of dielectric grains 111a included in the dielectric layer 111, and in an embodiment, 20% to 100%. In the above ranges, the permittivity, withstand voltage characteristics, Q-factor, and thermal stability of the multilayer ceramic capacitor 100 may be further improved. The number of dielectric grains having the core-shell structure and the total number of dielectric grains in the dielectric layer may be obtained from a TEM image of a cross-section (e.g., 1 μm²) of the dielectric layer 111. Other methods and/or tools appreciated by one of ordinary skill in the art, even if not described in the present disclosure, may also be used.

In the straight-line section (line a-b of FIG. 4) of the dielectric grain 111a having the core-shell structure, a length corresponding to the core portion C may be about 15 nm to 150 nm, and a total length corresponding to the shell portion SH may be 170 nm to 190 nm.

For example, a cross-section (L-T cross-section) cut perpendicular to the width direction in the length direction (L-axis direction) and the lamination direction (T-axis direction) at the center of the width direction (W-axis direction) of the multilayer ceramic capacitor 100 may be exposed. The L-T cross section may be exposed by fixing the multilayer ceramic capacitor 100 with epoxy resin and polishing it with a polisher. The polishing may be performed so that half of the width-direction (W-axis direction) length is deleted. In the exposed L-T cross-section, the active region is divided into three parts: upper, middle, and lower, and one dielectric layer 111 may be selected for each part. For each selected dielectric layer 111, three dielectric grains 111a may be randomly selected (a total of nine dielectric grains may be selected). For each of the selected dielectric grains 111a, a transmission electron microscope (TEM) analysis image is acquired, and in the TEM analysis image, the straight-line section (line a-b in FIG. 4) extending from one grain boundary GB of the dielectric grain 111a to another grain boundary GB and passing through the center point of the dielectric grain 111a may be set. In the straight-line section, a length corresponding to the core portion C and the shell portion SH may be measured from the center of the dielectric grain 111a. A length of each measured portion of the dielectric grains 111a may be averaged and evaluated as the final length of each portion. According to the final length above, the presence and location of the core portion C and the shell portion SH included in the dielectric grain 111a may be confirmed. Other methods and/or tools appreciated by one of ordinary skill in the art, even if not described in the present disclosure, may also be used.

The presence and location of the dielectric grains 111a may also be confirmed through transmission electron microscopy-energy dispersive X-ray spectroscopy (TEM-EDS) analysis. For example, Ca-rich and/or Zr-rich regions may be evaluated as the core portion C, Sr-rich and/or Ti-rich regions may be evaluated as the shell portion SH, and the Si-rich regions may be evaluated as the grain boundary GB.

The presence and location of the core portion C and the shell portion SH may be finally determined by synthesizing a length in the straight-line section and the results of TEM-EDS analysis.

The contents of the above-mentioned elements (Ti, Sr, Ca, Zr, first rare earth elements, second rare earth elements, etc.) in each of the shell portion SH and the core portion C may be measured through TEM-EDS analysis. The contents of the elements in each of the shell portion SH and the core portion C may be measured through TEM-EDS analysis of each of the nine selected dielectric grains 111a. The average of the contents of the nine measured elements may be evaluated as the contents of the elements. Other methods and/or tools appreciated by one of ordinary skill in the art, even if not described in the present disclosure, may also be used.

According to an embodiment, the average thickness (average length in the T-axis direction) of the dielectric layer 111 may be greater than about 0 μm and less than or equal to 0.7 μm. According to another example, the average thickness of the dielectric layer 111 may be greater than 0 μm and less than or equal to 0.65 μm. In the above ranges, the reliability of the multilayer ceramic capacitor 100 may be maintained or improved while being sufficiently thinned and made denser.

For example, the average thickness of the dielectric layer 111 may be obtained as the arithmetic average of the thicknesses of the dielectric layer 111 measured at 10 points spaced at predetermined intervals from a reference point, where the reference point is a center point in the length direction (L-axis direction) or width direction (W-axis direction) of the dielectric layer 111 in an SEM analysis image of a cross-section (L-T cross-section) cut perpendicular to the width direction in the length direction (L-axis direction) and the lamination direction (T-axis direction) at the center of the width direction (W-axis direction) of the multilayer ceramic capacitor 100. The intervals of the 10 points may be adjusted, depending on the scale of the SEM analysis image, and may be, for example, 1 μm to 100 μm, 1 μm to 50 μm, or 1 μm to 10 μm. In this case, all 10 points must be positioned within the dielectric layer 111, and if all 10 points are not positioned within the dielectric layer 111, the position of the reference point may be changed, or the interval between the 10 points may be adjusted.

The first internal electrode 121 and the second internal electrode 122 may have different polarities. For example, the first internal electrode 121 and the second internal electrode 122 may be alternately disposed to face each other in the T-axis direction with the dielectric layer 111 therebetween. For example, one end of the first internal electrode 121 may be exposed through the third surface of the capacitor body 110, and one end of the second internal electrode 122 may be exposed through the fourth surface of the capacitor body 110.

The first internal electrode 121 and the second internal electrode 122 may be electrically insulated from each other by the dielectric layer 111 disposed therebetween.

One end of the first internal electrode 121 exposed through the third surface of the capacitor body 110 may be electrically connected to the first external electrode 131. For example, one end of the second internal electrode 122 exposed through the fourth surface of the capacitor body 110 may be electrically connected to the second external electrode 132.

The first internal electrode 121 and the second internal electrode 122 may each include a conductive metal. For example, the conductive metal may include a metal such as Ni, Cu, Ag, Pd, Au, or an alloy thereof (e.g., an Ag—Pd alloy).

The first internal electrode 121 and the second internal electrode 122 may include dielectric particles of the same composition as the ceramic material included in the dielectric layer 111.

The first internal electrode 121 and the second internal electrode 122 may be formed using a conductive paste including a conductive metal. The printing method of the conductive paste may be a screen printing method or a gravure printing method.

According to an embodiment, the average thickness of the first internal electrode 121 and the second internal electrode 122 may be 0.1 μm to 2 μm. In the above range, as the multilayer ceramic capacitor 100 is implemented and thinned, resistance may be further reduced.

The average thickness of the first internal electrode 121 and the second internal electrode 122 may be measured by SEM analysis. The SEM analysis may be substantially identical to the above-described method of measuring the average thickness of the dielectric layer 111.

The Capacitor body 110 may be formed by firing a laminate in which a plurality of dielectric layers 111 and the internal electrodes 121 and 122 are laminated.

Referring to FIG. 2, the first external electrode 131 and the second external electrode 132 may have different polarities.

The first external electrode 131 may be electrically connected to the exposed portion of the first internal electrode 121. For example, the second external electrode 132 may be electrically connected to a portion where the second internal electrode 122 is exposed.

When a predetermined voltage is applied to the first external electrode 131 and the second external electrode 132, charges may be accumulated between the opposing first internal electrode 121 and the second internal electrode 122. Capacitance of the multilayer ceramic capacitor 100 may be proportional to the overlapped area on a plane of the first internal electrode 121 and the second internal electrode 122 that overlap each other in the lamination direction (T-axis direction) in the active region.

The first external electrode 131 and the second external electrode 132 may each include first and second connecting portions (not shown) disposed on the third surface and the fourth surface of the capacitor body 110 and connected to the first internal electrode 121 and the second internal electrode 122. The first external electrode 131 and the second external electrode 132 may each include first and second band portions (not shown) disposed at corners where the third surface and the fourth surface, the first surface and the second surface, or the fifth surface and the sixth surface of the capacitor body 110 meet.

The first and second band portions may each extend from the first and second connecting portions to a portion of the first surface and the second surface or the fifth surface and the sixth surface of the capacitor body 110. The first and second band portions may improve the adhesion strength of the first external electrode 131 and the second external electrode 132.

The external electrodes 131 and 132 may include electrode layers 10 and 20 positioned on the surface of the capacitor body 110.

The first external electrode 131 may include a first electrode layer 10 positioned directly on a surface (e.g., the third surface) of the capacitor body 110 and electrically connected to the first internal electrode 121. For example, the second external electrode 132 may include a second electrode layer 20 positioned directly on a surface (e.g., the fourth surface) of the capacitor body 110 and electrically connected to the second internal electrode 122.

The electrode layers 10 and 20 may include a conductive metal and glass.

The conductive metal may include copper (Cu), nickel (Ni), silver (Ag), palladium (Pd), gold (Au), platinum (Pt), tin (Sn), tungsten (W), titanium (Ti), lead (Pb), an alloy thereof, or a combination thereof for example, copper (Cu) may include a copper (Cu) alloy. When the conductive metal includes copper, a metal other than copper may be included in an amount of no more than 5 parts by mole based on 100 parts by mole of copper.

The glass may include a composition containing a mixture of oxides—for example, at least one selected from the group consisting of silicon oxide, boron oxide, aluminum oxide, transition metal oxide, alkali metal oxide, and alkaline-earth metal oxide.

The transition metal may be at least one selected from the group consisting of zinc (Zn), titanium (Ti), copper (Cu), vanadium (V), manganese (Mn), iron (Fe), and nickel (Ni), the alkali metal may be at least one selected from the group consisting of lithium (Li), sodium (Na), and potassium (K), and the alkali metal may be at least one selected from the group consisting of lithium (Li), sodium (Na), and potassium (K).

According to an embodiment, the external electrodes 131 and 132 may further include plating layers 30 and 40 positioned on the electrode layers 10 and 20.

The external electrodes 131 and 132 may optionally further include a conductive resin layer (not shown) positioned between the electrode layers 10 and 20 and the plating layers 30 and 40.

The conductive resin layer may extend to the first surface and the second surface or the fifth surface and the sixth surface of the capacitor body 110. In this case, a length of the region (e.g., a band portion) where the conductive resin layer is disposed may be longer than a length of the region (e.g., a band portion) where the electrode layers 10 and are disposed to extend to the first and second surfaces or the fifth and sixth surfaces of the capacitor body 110. For example, the conductive resin layer may entirely cover the electrode layers 10 and 20.

The conductive resin layer may include a resin and a conductive member.

The resin may be implemented by a material which has adhesive properties and shock absorption properties and is able to form a paste when mixed with the conductive member powder, but is not limited thereto. For example, the resin may include phenolic resin, acrylic resin, silicone resin, epoxy resin, or polyimide resin.

The conductive member may be electrically connected to the internal electrodes 121 and 122 or the electrode layers 10 and 20.

The conductive member may have a spherical shape, a flake shape, or a combination thereof. For example, the conductive member may be formed solely in the form of flakes, solely in the form of spherical shapes, or in the form of a mixture of flakes and spherical shapes.

The spherical shape may also include a shape that is not a perfect spherical shape—for example, a shape in which a length ratio of the major axis and the minor axis (major axis/minor axis) is 1.45 or less. Flake-shaped powder refers to a powder with a flat and elongated shape, and is not particularly limited, but may, for example, have a length ratio of the major axis and the minor axis (major axis/minor axis) of 1.95 or more.

The external electrodes 131 and 132 may further include the plating layers 30 and 40 disposed to cover the conductive resin layer described above.

The plating layers 30 and 40 may include a first plating layer 30 disposed on the first electrode layer 10 and a second plating layer 40 disposed on the second electrode layer 20.

The plating layers 30 and 40 may include nickel (Ni), copper (Cu), tin (Sn), palladium (Pd), platinum (Pt), gold (Au), silver (Ag), tungsten (W), titanium (Ti), or lead (Pb), or in an alloy thereof. These may be used alone or in combination of two or more.

The plating layers 30 and 40 may be a nickel (Ni) plating layer or a tin (Sn) plating layer. For example, the plating layers 30 and 40 may include a form in which the nickel (Ni) plating layer and Tin (Sn) plating layer are sequentially laminated, or may include a form in which Tin (Sn) plating layer, the nickel (Ni) plating layer, and Tin (Sn) plating layer are sequentially laminated. For example, the plating layers 30 and 40 may include a plurality of nickel (Ni) plating layers and/or a plurality of tin (Sn) plating layers.

The plating layers 30 and 40 may improve mountability, structural reliability, durability to the outside, heat resistance, and equivalent series resistance (ESR) of the multilayer ceramic capacitor 100 to the substrate.

Hereinafter, a method of manufacturing the multilayer ceramic capacitor 100 according to an embodiment will be described.

A method of manufacturing the multilayer ceramic capacitor 100 may include manufacturing the capacitor body 110 including the dielectric layer 111 and the internal electrodes 121 and 122, and forming the external electrodes 131 and 132 on the outside of the capacitor body 110.

In the manufacturing process of the capacitor body 110, a dielectric slurry that becomes the dielectric layer 111 after firing and a conductive paste that becomes the internal electrodes 121 and 122 after firing may be prepared.

A plasticized powder may be obtained by uniformly mixing and drying the dielectric powder by wet mixing or the like, and then heat-treating it under predetermined conditions. The dielectric slurry may be manufactured by adding an organic vehicle or an aqueous vehicle to the plasticized powder, heating, and mixing.

The dielectric powder may include Ca, Sr, Zr, and Ti. In an embodiment, the dielectric powder may be formed by doping Sr and Ti onto a base material including Ca and Zr. For example, the base material may include CaZrO₃.

The base material may be further doped with the first rare earth element and the second rare earth element described above. Accordingly, the permittivity and thermal stability of the dielectric layer 111 may be further improved together.

The doping may be performed through a hydrothermal synthesis method or a solid-phase synthesis method. The hydrothermal synthesis method may refer to a doping method performed by adding a raw material to water under conditions of 100° C. and 1 atm or higher. The solid-phase synthesis method may refer to a doping method performed by mixing multiple types of raw material powders.

The doping amount of Ti may be 5.5 parts by mole to 15 parts by mole based on 100 parts by mole of Ca. The doping amount of Sr may be 25 parts by mole to 65 parts by mole based on 100 parts by mole of Ca. In the above ranges, the shell portion SH of the above-described dielectric grains 111a is formed sufficiently and stably, so that the withstand voltage characteristics of the multilayer ceramic capacitor 100 may be further improved and the COG standard may be satisfied.

The dielectric slurry may be formed into a sheet using a technique such as a doctor blade method to obtain the dielectric green sheet. For example, the dielectric paste may include additives selected from various dispersants, plasticizers, dielectrics, sub-component compounds, and/or glasses.

The conductive paste for the internal electrodes may be prepared by mixing a conductive powder made of a conductive metal or an alloy thereof with a binder or solvent.

The conductive paste for the internal electrodes may contain indium (In).

The conductive paste for the internal electrodes may contain a ceramic powder (for example, barium titanate powder) as a co-material. The co-material may suppress sintering of the conductive powder during the firing process.

The conductive paste for the internal electrodes may be applied in a predetermined pattern on the surface of the dielectric green sheet using various printing methods such as screen printing or a transfer method. The dielectric green sheet having an internal electrode pattern formed thereon may be laminated in a plurality of layers and pressed in the lamination direction to obtain the dielectric green sheet laminate. The dielectric green sheet and the internal electrode pattern may be laminated such that the dielectric green sheet is positioned on the upper and lower surfaces of the lamination direction of the dielectric green sheet laminate.

Optionally, the dielectric green sheet laminate may be cut to a predetermined size by dicing or the like.

The dielectric green sheet laminate may be solidified and dried to remove plasticizers, etc., if necessary, and after being solidified and dried, the dielectric green sheet laminate may be barrel polished using a horizontal centrifugal barrel machine, or the like. In the above barrel polishing, the dielectric green sheet laminate is placed into a barrel container with media and polishing liquid, and rotational motion or vibration is applied to the barrel container, thus unnecessary parts, such as burrs generated during cutting, may be polished. For example, after barrel polishing, the dielectric green sheet laminate may be washed with a cleaning solution such as water and dried.

The capacitor body may be obtained after binder removal treatment and firing of the dielectric green sheet laminate.

The conditions of a debinder treatment may be appropriately adjusted depending on the primary component composition of the dielectric layer or the primary component composition of the internal electrode. For example, the rate of temperature rise during the debinder treatment may be 5° C./hour to 300° C./hour, the support temperature may be 180° C. to 400° C., and the temperature holding time may be 0.5 hours to 24 hours. The debinder atmosphere may be air or a reducing atmosphere.

The conditions for the firing may be appropriately adjusted, depending on the primary components of the dielectric layer or the internal electrode layer. For example, the temperature during firing may be 1200° C. to 1350° C., or 1220° C. to 1300° C., and Time may be 0.5 hours to 8 hours, or 1 hour to 3 hours. The firing atmosphere may be a reducing atmosphere—for example, an atmosphere in which a mixed gas of nitrogen gas (N₂) and hydrogen gas (H₂) is humidified. When the internal electrodes 121 and 122 include nickel (Ni) or a nickel (Ni) alloy, the oxygen partial pressure in the firing atmosphere may be 1.0×10⁻¹⁴ MPa to 1.0×10⁻¹⁰ MPa.

After the firing, annealing may be performed as needed. Annealing is a treatment to reoxidize the dielectric layer, and annealing may be performed if firing is performed in a reducing atmosphere. The conditions of the annealing treatment may also be appropriately adjusted depending on the primary component composition of the dielectric layer. For example, the annealing temperature may be 950° C. to 1150° C., Time may be 0 to 20 hours, and the rate of temperature rise may be 50° C./hour to 500° C./hour. The annealing atmosphere may be a humidified nitrogen gas (N₂) atmosphere, and the oxygen partial pressure may be 1.0×10⁻⁹ MPa to 1.0×10⁻⁵ MPa.

In a binder removal treatment, firing treatment, or annealing treatment, for example, a wetter may be used to humidify nitrogen gas or mixed gas. In this case, the water temperature may be 5° C. to 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the obtained the capacitor body 110. By performing this surface treatment, the ends of the first internal electrode 121 and the second internal electrode 122 may be exposed to the surfaces of the third and fourth surfaces. Accordingly, the electrical connection between the first external electrode 131 and the second external electrode 132, and the first internal electrode 121 and the second internal electrode 122 may be improved, so alloy portions may be easily formed.

The electrode layers 10 and 20 may be formed by applying and sintering a paste for forming an electrode layer on the outer surface of the capacitor body 110, thereby manufacturing the external electrodes 131 and 132.

The paste for forming the electrode layer may include a conductive metal and a glass composition.

The conductive metal may include Ni and an auxiliary element including at least one of Sn, Al, Zn, In, and Co. An alloy of the auxiliary element and Ni is formed by sintering, and thus the connection between the internal electrodes 121 and 122 and the external electrodes 131 and 132 may be improved.

The glass composition may include at least one selected from the group consisting of Si oxide, Al oxide, Fe oxide, Sn oxide, Zn oxide, Li oxide, Na oxide, K oxide, Ba oxide, Ca oxide, Sr oxide, B oxide, Ni oxide, Mn oxide, Ge oxide, Cu oxide, In oxide, Co oxide, Ti oxide, and P oxide.

For example, the glass composition may include Li₂O, Na₂O, K₂O, SiO₂, Al₂O₃, FeO, Fe₂O₃, Fe₃O₄, NiO, Ni₂O₃, Ni₃O₄, In₂O₃, TiO₂, P₂O₅, BaO, CaO, SrO, B₂O₃, ZnO, SnO, SnO₂, Cu₂O, CuO, CoO, Co₂O₃, GeO₂, MnO, Mn₂O, Mn₂O₃, Mn₃O₄, and the like. These may be used alone or in a combination of two or more.

Glass may be produced by mixing the components of the glass composition, heat-treating them at a certain temperature or higher, rapidly cooling them, and then atomizing them, or by using a gaseous, liquid, or spray pyrolysis method.

The paste for forming the electrode layer may further include a binder, a solvent, a dispersant, a plasticizer, an oxide powder, or the like.

The binder may include, for example, ethyl cellulose, acryl, or butyral, and the solvent may include, for example, an organic solvent or an aqueous solvent such as terpineol, butyl carbitol, alcohol, methyl ethyl ketone, acetone, toluene, or the like. The content of Ni among a total amount of Ni and the auxiliary elements included in the paste for forming an electrode layer may be 80 mol % to 95 mol %. In the above range, Capacity characteristics of the multilayer ceramic capacitor 100 may be further improved, and the connection stability of the internal electrodes 121 and 122 and the external electrodes 131 and 132 may be further improved.

The content of the auxiliary element among a total amount of Ni and the auxiliary element included in the paste for forming the electrode layer may be 5 mol % to 20 mol %. In the above range, the driving reliability of the multilayer ceramic capacitor 100 may be further improved while the deterioration of Capacity characteristics may be suppressed.

Methods for applying the paste for forming the electrode layer on the outer surface of the capacitor body 110 may include various printing methods such as a dip method and screen printing, an application method using a dispenser, etc., and a spraying method using a spray. The paste for forming the electrode layer may be applied to at least the third and fourth surfaces of the capacitor body 110, and optionally applied to a part of the first, second, fifth, or sixth surfaces on which the band portions of the first and second external electrodes are formed.

The sintering may be performed at a temperature of 500° C. to 850° C. In the above range, an alloy of Ni and auxiliary elements may be sufficiently formed, and the connection stability of the internal electrodes 121 and 122 and the external electrodes 131 and 132 may be further improved.

Next, optionally, a paste for forming a conductive resin layer may be applied to the outer surface of the capacitor body 110 on which the electrode layers 10 and 20 are formed, and then cured to form a conductive resin layer.

The paste for forming the conductive resin layer may include a resin and, optionally, a conductive metal or a non-conductive filler. Since the description of the conductive metal and resin is the same as described above, repeated description will be omitted. Additionally, the paste for forming the conductive resin layer may optionally include a binder, solvent, dispersant, plasticizer, or oxide powder. The binder may include, for example, ethyl cellulose, acryl, or butyral, etc., and the solvent may include an organic solvent or an aqueous solvent such as terpineol, butyl carbitol, alcohol, methyl ethyl ketone, acetone, or toluene, etc.

For example, the conductive resin layer may be formed by dipping the capacitor body 110 in a paste for forming the conductive resin layer and then curing it, or by printing the paste for forming the conductive resin layer on the surface of the capacitor body 110 by a screen printing method or a gravure printing method, or by applying the paste for forming the conductive resin layer to the surface of the capacitor body 110 and then curing it.

The plating layers 30 and 40 may be formed on the outside of the conductive resin layer.

The plating layers 30 and 40 may be formed by a plating method, sputtering, or electrolytic plating (electric deposition).

Specific embodiments of the present disclosure are provided below. However, the examples described below are only intended to specifically illustrate or describe the present disclosure.

### Examples 1 to 21 and Comparative Examples 1 to 21

A dielectric powder doped with Sr and Ti was manufactured by solid-phase mixing SrTiO₃ powder with CaZrO₃, a base powder. At this time, the doping amount was adjusted so that Ti content in a total amount of Zr and Ti included in the shell portion was as described in Table 1, and Sr content in a total amount of Ca and Sr included in the shell portion was as described in Table 1.

A dielectric slurry was prepared by mixing the dielectric powder and solvent.

A dielectric green sheet was manufactured using the dielectric slurry, and a conductive paste layer containing Ni was printed on the surface of the dielectric green sheet. The dielectric green sheet (width×length×height=3.2 mm×2.5 mm×2.5 mm) on which the conductive paste layer was formed was laminated and pressed to prepare a dielectric green sheet laminate.

The dielectric green sheet laminate was plasticized under conditions of 400° C. or lower, in a nitrogen atmosphere, and then fired at the temperature (firing temperature) and hydrogen concentration described in Table 1 to manufacture a capacitor body.

Next, a multilayer ceramic capacitor was manufactured through processes such as external electrodes and plating.

### Evaluation 1: TEM-EDS and Line Scanning Analysis

The multilayer ceramic capacitor was polished using a polisher to expose a cross-section (L-T cross-section) cut in the length direction (L-axis direction) and the lamination direction (W-axis direction) perpendicular to the width direction at the center of the width direction (W-axis direction). The active region of the L-T cross-section was divided into three parts: upper, middle, and lower, and one dielectric layer was selected for each part. For each selected dielectric layer, three dielectric grains were randomly selected (a total of nine dielectric grains were selected). For the selected dielectric grains, TEM analysis was performed and TEM analysis images were obtained. The TEM analysis was measured under 10 k magnification and 200 kV acceleration voltage. In each of the TEM analysis images, a straight-line section extending from one grain boundary to another of the dielectric grains and passing through the center point was set, and EDS mapping analysis and line scanning analysis were performed along the straight-line section. The device used in the analysis is JEOL's JEM-ARM200F.

In the straight-line section, the region having the highest contents of Ca and Zr, the lowest content of Ti, and a length of about 15 nm to 150 nm passing through the center point was evaluated as the core portion. In the straight-line section, the region in contact with the core portion, having the largest Ti content and a total length of about 170 nm to 190 nm was evaluated as the shell portion. In the straight-line section, the region in contact with the shell portion, having the largest Si content and a total length of about 20 nm or less, was evaluated as a grain boundary. A total length of the above-described shell portion is the sum of the lengths of two of the shell portions included in the straight-line section, and a total length of the above-described grain boundary is the sum of the lengths of two of the grain boundaries included in the straight-line section.

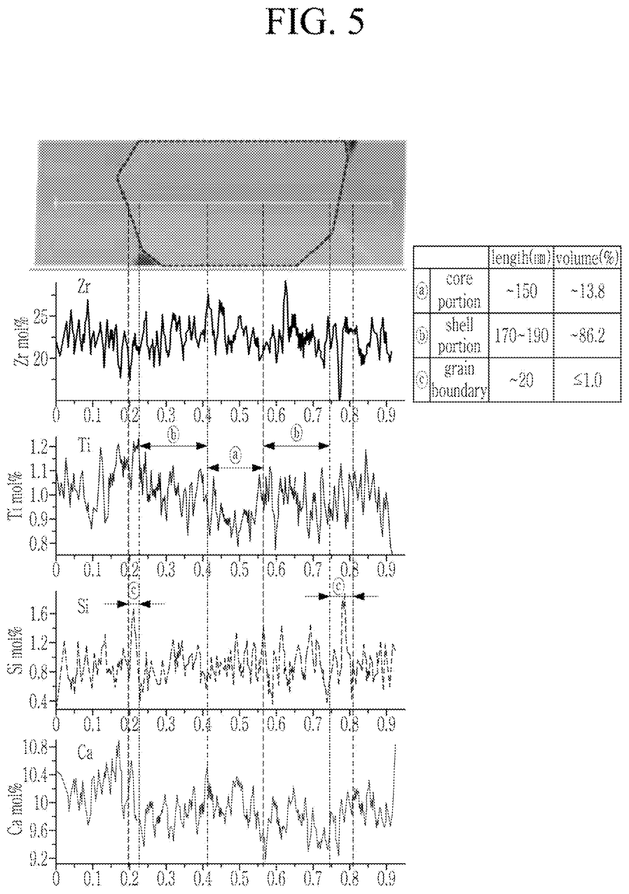

FIG. 5 shows a TEM-EDS analysis image and line scanning analysis results for dielectric grains of a multilayer ceramic capacitor according to Example 1.

Referring to FIG. 5, the contents of Ca and Zr were high in the core portion (\textcircled{a}) and the content of Ti was the lowest, the content of Ti was the highest in the shell portion (\textcircled{b}), and the content of Si was the highest in the grain boundary (\textcircled{c}). By doping Ti and Sr in the dielectric powder formation step, the largest Ti content was measured in the shell portion rather than the grain boundary. Accordingly, the withstand voltage characteristics and stability of the multilayer ceramic capacitor were improved.

TABLE 1

| | | Hydrogen | | |
|---|---|---|---|---|
| | Firing | concen- | Ti | Sr |
| | temperature | tration | contents | contents |
| | (° C.) | (% H₂) | (mol %) | (mol %) |
| Example 1 | 1180 | 0.5 | 5 | 35 |
| Example 2 | | | 7 | |
| Example 3 | | | 10 | |
| Example 4 | | 1.0 | 5 | |
| Example 5 | | | 7 | |
| Example 6 | | | 10 | |
| Example 7 | 1200 | 0.25 | 5 | |
| Example 8 | | | 7 | |
| Example 9 | | | 10 | |
| Example 10 | | 0.5 | 5 | |
| Example 11 | | | 7 | |
| Example 12 | | | 10 | |
| Example 13 | | 0.25 | 7 | 32 |
| Example 14 | | | | 35 |
| Example 15 | | | | 40 |
| Example 16 | | 0.5 | | 32 |
| Example 17 | | | | 35 |
| Example 18 | | | | 50 |
| Example 19 | | 1.0 | | 32 |
| Example 20 | | | | 35 |
| Example 21 | | | | 65 |
| Comparative Example 1 | 1180 | 0.5 | 3 | 35 |
| Comparative Example 2 | | | 15 | |
| Comparative Example 3 | | | 20 | |
| Comparative Example 4 | | 1.0 | 3 | |
| Comparative Example 5 | | | 15 | |
| Comparative Example 6 | | | 20 | |
| Comparative Example 7 | 1200 | 0.25 | 3 | |
| Comparative Example 8 | | | 15 | |
| Comparative Example 9 | | | 20 | |
| Comparative Example 10 | | 0.5 | 3 | |
| Comparative Example 11 | | | 15 | |
| Comparative Example 12 | | | 20 | |
| Comparative Example 13 | | 0.25 | 7 | 28 |
| Comparative Example 14 | | | | 30 |
| Comparative Example 15 | | | | 70 |
| Comparative Example 16 | | 0.5 | | 28 |
| Comparative Example 17 | | | | 30 |
| Comparative Example 18 | | | | 70 |
| Comparative Example 19 | | 1.0 | | 28 |
| Comparative Example 20 | | | | 30 |
| Comparative Example 21 | | | | 70 |

### Evaluation 2: Measurement of Room Temperature Permittivity(s) and Q-Factor

Capacitance (Cp) and dissipation factor (DF) were measured using Agilent's capacitance meter (model number: 4268A), and a room temperature permittivity & was converted from the measured Cp by considering the dielectric thickness, number of layers, and electrode overlap area.

The reciprocal of the measured DF (1/DF) was evaluated as the Q-factor.

### Evaluation 3: Evaluation of Temperature Coefficient of Capacitance (TCC)

The multilayer ceramic capacitors of the examples and comparative examples described above were introduced into an LCR meter including a temperature variable chamber. The temperature of the temperature variable chamber was slowly increased from −55° C. to 150° C., and the chamber was left at −55° C., 25° C., and 125° C. for 5 to 10 minutes, and then Capacitance was measured. The rate of change in capacitance at each temperature was measured based on Capacitance at 25° C., and evaluated as the temperature coefficient of capacitance (TCC).

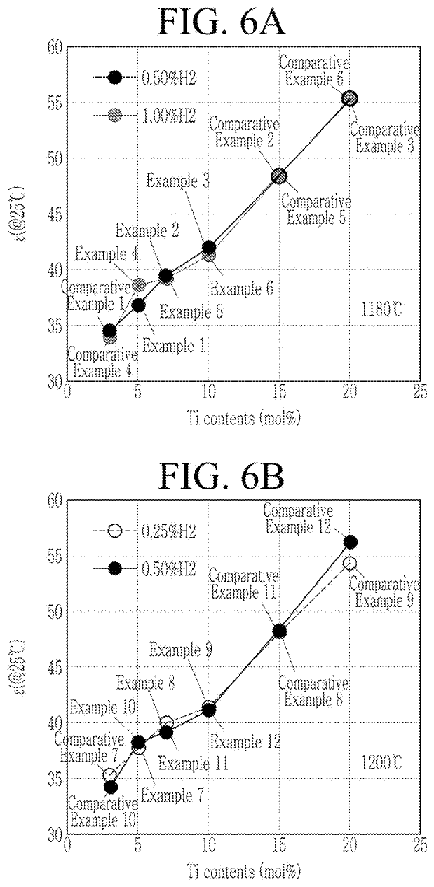

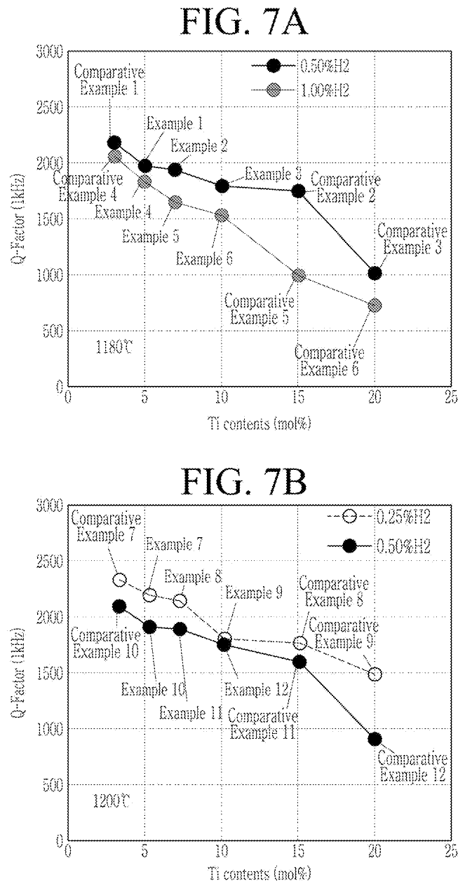

FIGS. 6A and 6B are graphs showing the permittivity according to Titanium (Ti) content of a dielectric layer of the multilayer ceramic capacitor according to Examples 1 to 12 and Comparative Examples 1 to 12. FIGS. 7A and 7B are graphs showing the quality factor (Q-factor) according to Ti content of the dielectric layer of the multilayer ceramic capacitor according to Examples 1 to 12 and Comparative Examples 1 to 12.

Referring to FIGS. 6A, 6B, 7A, and 7B and Table 1 above, in examples in which Ti content was 5 mol % to 10 mol % based on a total amount of Zr and Ti included in the shell portion and Sr content was 32 mol % to 65 mol % based on a total amount of Ca and Sr included in the shell portion, both the room temperature permittivity and the Q-factor were maintained within an appropriate range compared to comparative examples in which Ti content was outside the above range.

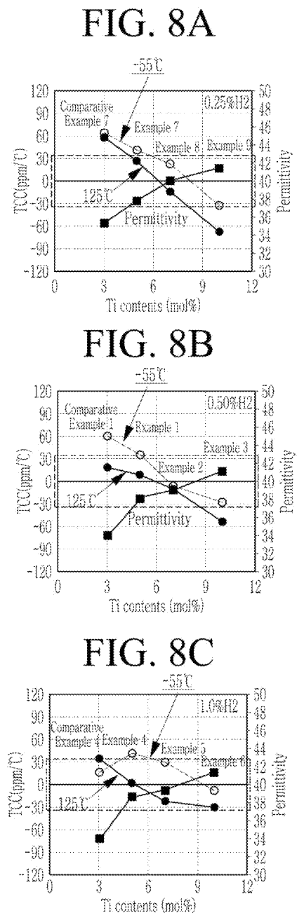

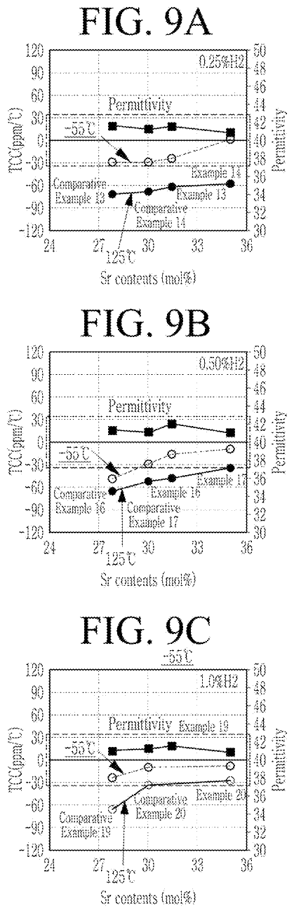

FIGS. 8A to 8C are graphs showing the TCC and the permittivity according to Ti content of the dielectric layer of the multilayer ceramic capacitor according to Examples 1 to 9 and Comparative Examples 1, 4, and 7. FIGS. 9A to 9C are graphs showing the permittivity and TCC according to the strontium (Sr) content of the dielectric layer of the multilayer ceramic capacitor according to Examples 13, 14, 16, 17, 19, and 20 and Comparative Examples 13, 14, 16, 17, 19, and 20.

Referring to FIGS. 8A, 8B, 9A, and 9B and Table 1 above, in examples in which Ti content was 5 mol % to 10 mol % based on a total amount of Zr and Ti included in the shell portion and Sr content was 32 mol % to 65 mol % based on a total amount of Ca and Sr included in the shell portion, the change in capacitance according to temperature change was reduced while the permittivity was improved compared to the comparative examples.

As shown in FIG. 9 and Table 1 above, in examples in which Ti content was 5 mol % to 10 mol % based on a total amount of Zr and Ti included in the shell portion and Sr content was 32 mol % to 65 mol % based on a total amount of Ca and Sr included in the shell portion, the room temperature permittivity and Q-factor were improved compared to comparative examples in which Sr content was outside the above range.

### Examples 22 to 37

A multilayer ceramic capacitor was manufactured in the same manner as in Example 1, except that CaZrO₃ powder was further doped with (Dy source and Y source) so that parts by mole R1 of Dy and parts by mole R2 of Y based on 100 parts by mole of Ca included in the shell portion were as described in Table 2 below, and the firing temperature and the hydrogen concentration were adjusted so as to be as described in Table 2 below.

TABLE 2

| | | | Dy | Y |
|---|---|---|---|---|
| | Firing | Hydrogen | contents | contents |
| | temperature | concentration | (R1) (parts | (R2) (parts |
| | (° C.) | (% H₂) | by mole) | by mole) |
| Example 22 | 1180 | 0.5 | 0 | 3.0 |
| Example 23 | | | 0.8 | 2.2 |
| Example 24 | | | 1.2 | 1.8 |
| Example 25 | | | 2.5 | 0.5 |
| Example 26 | | 1.0 | 0 | 3.0 |
| Example 27 | | | 0.8 | 2.2 |
| Example 28 | | | 1.2 | 1.8 |
| Example 29 | | | 2.5 | 0.5 |
| Example 30 | 1200 | 0.25 | 0 | 3.0 |
| Example 31 | | | 0.8 | 2.2 |
| Example 32 | | | 1.2 | 1.8 |
| Example 33 | | | 2.5 | 0.5 |
| Example 34 | | 0.5 | 0 | 3.0 |
| Example 35 | | | 0.8 | 2.2 |
| Example 36 | | | 1.2 | 1.8 |
| Example 37 | | | 2.5 | 0.5 |

### Evaluation 4: Measurement of Room Temperature Permittivity and Q-Factor

The room temperature permittivity and Q-factor of Examples 22 to 37 were measured using the same device and method as in Evaluation 2 described above.

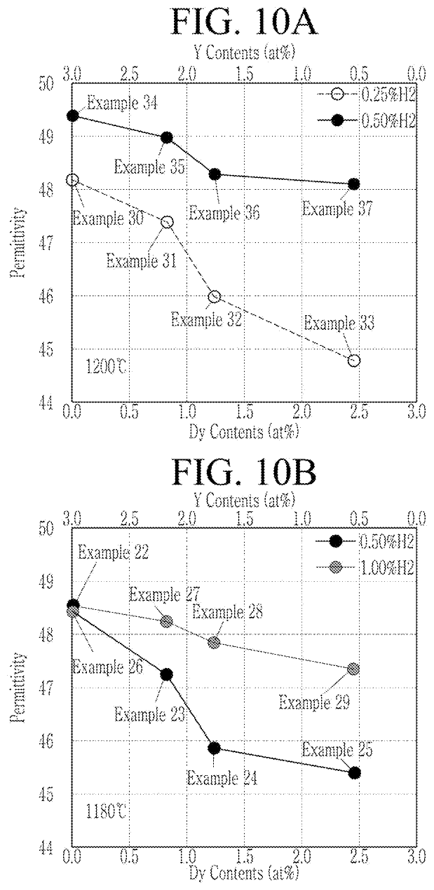

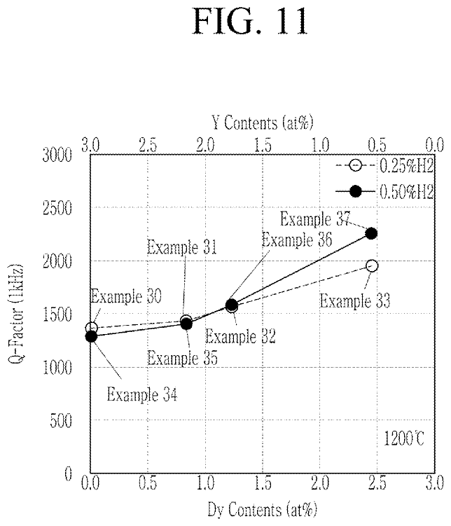

FIGS. 10A and 10B are graphs showing the permittivity according to the dysprosium (Dy) and yttrium (Y) content of the dielectric layer of the multilayer ceramic capacitor according to Examples 22 to 37. FIG. 11 is a series of graphs showing the Q-factor according to the Dy and Y contents of the dielectric layer of the multilayer ceramic capacitor according to Examples 22 to 37.

Referring to FIGS. 10A, 10B, and 11 and Table 2 above, in Examples 23 to 25, 27 to 29, 31 to 33, and 35 to 37 satisfying 0.05≤R1≤3.45, 0.05≤R2≤3.45 and 0.1≤R1+R2≤3.5, both the permittivity and the Q-factor were improved compared to Examples 22, 26, 30, and 34 which were outside the above ranges.

What is claimed is:

1. A multilayer ceramic capacitor, comprising:
a capacitor body including a dielectric layer and an internal electrode layer; and
an external electrode located on an outside of the capacitor body,
wherein the dielectric layer comprises a plurality of dielectric grains,
at least one dielectric grain among the plurality of dielectric grains comprises Ca, Sr, Zr, and Ti,
the at least one dielectric grain having a core-shell structure including a core portion and a shell portion disposed on at least a portion of the core portion,
a content of Ti included in the shell portion is 5 mol % to 10 mol % based on a total amount of Zr and Ti included in the shell portion, and
a content of Sr included in the shell portion is 32 mol % to 65 mol % based on a total amount of Ca and Sr included in the shell portion.

2. The multilayer ceramic capacitor of claim 1, wherein
a content of Ti included in the core portion is greater than 0 mol % and less than mol % based on a total amount of Zr and Ti included in the core portion.

3. The multilayer ceramic capacitor of claim 1, wherein
a content of Sr included in the core portion is greater than 0 mol % and less than 32 mol % based on a total amount of Ca and Sr included in the core portion.

4. The multilayer ceramic capacitor of claim 1, wherein
the dielectric grains further comprise a first rare earth element, and a second rare earth element different from the first rare earth element.

5. The multilayer ceramic capacitor of claim 4, wherein
the first rare earth element comprises at least one element selected from the group consisting of elements having an ionic radius larger than that of yttrium (Y).

6. The multilayer ceramic capacitor of claim 4, wherein
the first rare earth element comprises at least one selected from Gd, Dy, Sm, and La.

7. The multilayer ceramic capacitor of claim 4, wherein
the second rare earth element comprises at least one selected from the group consisting of Y and elements having an ionic radius smaller than that of Y.

8. The multilayer ceramic capacitor of claim 4, wherein
the second rare earth element comprises at least one selected from Y, Yb, and Ho.

9. The multilayer ceramic capacitor of claim 4, wherein
an amount in parts by mole of the first rare earth element included in the shell portion based on 100 parts by mole of Ca included in the shell portion is defined as R1, and an amount in parts by mole of the second rare earth element included in the shell portion based on 100 parts by mole of Ca included in the shell portion is defined as R2, and
$$0.05 \leq R 1 \leq 3.45 , 0.05 \leq R 2 \leq 3.45 , and 0.1 \leq R 1 + R 2 \leq 3.5 .$$

10. The multilayer ceramic capacitor of claim 4, wherein
an amount in parts by mole of the first rare earth element included in the shell portion based on 100 parts by mole of Ca included in the shell portion is defined as R1, and an amount in parts by mole of the second rare earth element included in the shell portion based on 100 parts by mole of Ca included in the shell portion is defined as R2, and
$$0.8 \leq R 1 \leq 1. , 2.2 \leq R 2 \leq 3. , and 3. \leq R 1 + R 2 \leq 3.5 .$$

11. The multilayer ceramic capacitor of claim 4, wherein
an amount in parts by mole of the first rare earth element included in the core portion based on 100 parts by mole of Ca included in the core portion is defined as R3, and an amount in parts by mole of the second rare earth element included in the core portion based on 100 parts by mole of Ca included in the core portion is defined as R4, and
$$0 \leq R 3 + R 4 \leq 0.5 .$$

12. The multilayer ceramic capacitor of claim 1, wherein
in a cross-section passing through a center of the at least one dielectric grain, the center of the at least one dielectric grain is defined as a, and a point on a surface of the shell portion farthest from a is defined as b,
and a length of the core portion is 15% to 85% of a shortest length from a to b.

13. The multilayer ceramic capacitor of claim 1, wherein
a number of the at least one dielectric grain is 5% to 100% of a total number of dielectric grains included in the dielectric layer.

14. The multilayer ceramic capacitor of claim 1, wherein
in a straight-line section extending from one grain boundary of the at least one dielectric grain to another grain boundary and passing through a center point of the at least one dielectric grain,
a length corresponding to the core portion is 15 nm to 150 nm, and
a total length corresponding to the shell portion is 170 nm to 190 nm.

15. A method of manufacturing the multilayer ceramic capacitor according to claim 1, comprising:
preparing a dielectric powder doped with Sr and Ti in a base material containing Ca and Zr;
preparing a dielectric slurry containing the dielectric powder;
preparing a plurality of dielectric green sheets from the dielectric slurry and forming a conductive paste layer on a surface of at least one dielectric green sheet among the plurality of dielectric green sheets;
laminating the plurality of the dielectric green sheets having the conductive paste layer formed on the at least one dielectric green sheet to prepare a dielectric green sheet laminate;
firing the dielectric green sheet laminate to manufacture a capacitor body including a dielectric layer and an internal electrode; and
forming an external electrode on a surface of the capacitor body.

16. The method of manufacturing the multilayer ceramic capacitor of claim 15, wherein
a doping amount of Ti is 5.5 parts by mole to 15 parts by mole based on 100 parts by mole of Ca.

17. The method of manufacturing the multilayer ceramic capacitor of claim 15, wherein
a doping amount of Sr is 25 parts by mole to 65 parts by mole based on 100 parts by mole of Ca.

18. The method of manufacturing the multilayer ceramic capacitor of claim 15, wherein
the base material is further doped with a first rare earth element and a second rare earth element different from the first rare earth element.

19. The method of manufacturing the multilayer ceramic capacitor of claim 18, wherein
the first rare earth element comprises at least one selected from Gd, Dy, Sm, and La.

20. The method of manufacturing the multilayer ceramic capacitor of claim 18, wherein
the second rare earth element comprises at least one selected from Y, Yb, and Ho.
